(19) United States
(12) Patent Application Publication
(10) Pub. No.: US 2026/0006649 A1
(43) Pub. Date: Jan. 1, 2026

(54) METHOD AND DEVICE FOR INITIAL ACCESS IN NON-TERRESTRIAL NETWORK

(71) Applicant: ELECTRONICS AND TELECOMMUNICATIONS RESEARCH INSTITUTE, Daejeon (KR)

(72) Inventor: Hee Wook KIM, Daejeon (KR)

(73) Assignee: ELECTRONICS AND TELECOMMUNICATIONS RESEARCH INSTITUTE, Daejeon (KR)

(21) Appl. No.: 19/112,880

(22) PCT Filed: Sep. 26, 2023
(86) PCT No.: PCT/KR2023/014797

§ 371 Date: Mar. 18, 2025

(30) Foreign Application Priority Data
Sep. 26, 2022 (KR) 10-2022-0121287

(51) Int. Cl. H04W 74/0833; H04L 27/26; H04W 56/00

(52) U.S. Cl. CPC H04W 74/0833; H04L 27/2613; H04L 27/26132; H04W 56/001

(57) ABSTRACT

The present disclosure provides a random access method. A method according to an embodiment of the present disclosure, performed by a terminal using an asynchronous grant-free non-orthogonal multiple access scheme, may comprise the steps of: acquiring random access preamble generation information from a base station; generating a primary random access preamble on the basis of the random access preamble generation information; and transmitting the generated primary random access preamble to the base station.

### TECHNICAL FIELD

The present disclosure relates to an initial access technique for a system having a large cell radius, and more particularly, to an initial access technique in a non-terrestrial network.

### BACKGROUND ART

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

The communication network mentioned may primarily refer to a terrestrial network as it caters to communication needs for devices located on the terrestrial locations. However, there's a growing demand for communication services for unmanned aerial vehicles and satellites, which operate not only on terrestrial but also non-terrestrial locations. In response to this demand, the 3rd Generation Partnership Project (3GPP) is actively discussing technologies for a non-terrestrial network (NTN).

The post-5G mobile communication networks are expected to evolve toward combining or cooperating a terrestrial network (TN) with a satellite network (e.g. non-terrestrial network (NTN)). In this satellite/terrestrial integrated system, commonality between satellite and terrestrial radio interfaces should be considered very important when considering costs of the terminal. Accordingly, NR-based NTN standardization is currently actively underway in the 3GPP. The NTN, as opposed to TN, needs to account for characteristics such as long round-trip delay, latency variations among terminals, large cell coverage, significant Doppler shifts between base stations and terminals, and constrained power environment typically found in satellite configurations. Based on these considerations, standardization and research on NTN radio interfaces, utilizing NR/LTE/NB-IoT technologies, are underway within the framework of 3GPP standards.

Furthermore, to enhance cell capacity and support a larger number of terminals concurrently within the constraints of limited frequency resources, research on non-orthogonal multiple access techniques is actively progressing, which belong to a fundamental technology for future-generation mobile communications beyond 5G, enabling simultaneous transmission of signals for multiple users over the same time, frequency, and spatial resources to enhance spectral efficiency.

The NR-based mobile communication system for NTN or similar systems with very large cells requires an initial access channel structure and method for asynchronous, grant-free, non-orthogonal multiple access (NOMA) support for terminals.

### DISCLOSURE

### Technical Problem

The present disclosure is directed to providing an initial (random) access channel and a method for initial (random) access in an NR/LTE-based mobile communication system, which are for improving initial (random) access performance while minimizing impacts on the existing NR/LTE specifications, particularly in situations where global navigation satellite system (GNSS) information of a terminal and ephemeris information of a satellite are not available.

### Technical Solution

A method according to an exemplary embodiment of the present disclosure for achieving the above-described objective, as a method of a terminal, may comprise: obtaining random access preamble generation information from a base station; generating a primary random access preamble based on the random access preamble generation information; transmitting the generated primary random access preamble to the base station; receiving a primary random access response including primary timing advance (TA) information from the base station; generating a secondary random access preamble based on the primary random access response; transmitting the secondary random access preamble to the base station based on the primary TA information; receiving a secondary random access response including secondary TA information from the base station; and transmitting a connection request to the base station at a transmission timing based on the primary TA information and the secondary TA information, wherein the first random access preamble and the second random access preamble have different configurations.

In the generating of the primary random access preamble, if a length of an orthogonal frequency division multiplexing (OFDM) symbol for the primary random access preamble is n times a length of a cyclic prefix (CP) for the primary random access preamble, the primary random access preamble may be generated to have a structure repeated in units of the length of the CP, and n is a natural number.

When the primary random access preamble is generated to have the structure repeated in units of the length of the CP, the primary random access preamble may be transmitted in subcarriers having indices (n×k) in a frequency domain of the OFDM symbol, and k is an integer.

In the generating of the primary random access preamble, if a length of an OFDM symbol for the primary random access preamble is not n times a length of a CP for the primary random access preamble, the primary random access preamble may be generated to have a structure in which the OFDM symbol is repeated in units of a greatest common divisor of a number of samples for the CP and a number of samples for the OFDM symbol, and n is a natural number.

When the primary random access preamble is generated to have the structure in which the OFDM symbol is repeated in units of the greatest common divisor, the primary random access preamble may be transmitted in subcarriers having indices corresponding to integer multiples of a repetition factor p within the OFDM symbol of the primary random access preamble, and p is a natural number.

In the generating of the secondary random access preamble, the secondary random access preamble may be generated by repeating an OFDM symbol for the secondary random access preamble twice in time, excluding a cyclic prefix for the secondary random access preamble.

The primary TA information may be information for adjusting an uplink timing within a CP period, and the secondary TA information may be information for correcting the primary TA information.

The primary random access preamble and the secondary random access preamble may be transmitted in different frames, the primary random access preamble may be transmitted in a plurality of preconfigured subframes within a frame in which the primary random access preamble is configured to be transmitted, and the secondary random access preamble may be transmitted in some symbols of a frame in which the secondary random access preamble is configured to be transmitted.

A method according to an exemplary embodiment of the present disclosure for achieving the above-described objective, as a method of a base station, may comprise: broadcasting random access preamble generation information; in response to detecting receipt of a primary random access preamble from a terminal, generating primary timing advance (TA) information based on a structure of the primary random access preamble; transmitting, to the terminal, a primary random access response including a primary random access preamble identifier (ID), an uplink grant message, and the primary TA information; in response to detecting receipt of a secondary random access preamble from the terminal, generating secondary TA information based on a structure of the secondary random access preamble; transmitting, to the terminal, a secondary random access response including a secondary random access preamble ID, an uplink grant message, and the secondary TA information; and establishing a connection with the terminal when a connection request is received from the terminal, wherein the first random access preamble and the second random access preamble have different configurations.

When a length of an orthogonal frequency division multiplexing (OFDM) symbol for the primary random access preamble is n times a length of a cyclic prefix (CP) for the primary random access preamble, the primary random access preamble may be generated to have a structure repeated in units of the length of the CP, and n is a natural number.

When the primary random access preamble is generated to have the structure repeated in units of the length of the CP, the primary random access preamble may be received in subcarriers having indices (n×k) in a frequency domain of the OFDM symbol, and k is an integer.

When a length of an OFDM symbol for the primary random access preamble is not n times a length of a CP for the primary random access preamble, the primary random access preamble may be generated to have a structure in which the OFDM symbol is repeated in units of a greatest common divisor of a number of samples for the CP and a number of samples for the OFDM symbol, and n is a natural number.

When the primary random access preamble is generated to have the structure in which the OFDM symbol is repeated in units of the greatest common divisor, the primary random access preamble may be received in subcarriers having indices corresponding to integer multiples of a repetition factor p within the OFDM symbol of the primary random access preamble, and p is a natural number.

The secondary random access preamble may be generated by repeating an OFDM symbol for the secondary random access preamble twice in time, excluding a cyclic prefix for the secondary random access preamble.

The primary TA information may be information for adjusting an uplink timing within a CP period, and the secondary TA information may be information for correcting the primary TA information.

The primary random access preamble and the secondary random access preamble may be transmitted in different frames, the primary random access preamble may be transmitted in a plurality of preconfigured subframes within a frame in which the primary random access preamble is configured to be transmitted, and the secondary random access preamble may be transmitted in some symbols of a frame in which the secondary random access preamble is configured to be transmitted.

A terminal according to an exemplary embodiment of the present disclosure for achieving the above-described objective comprises a processor, and the processor causes the terminal to perform:
obtaining random access preamble generation information from a base station; generating a primary random access preamble based on the random access preamble generation information; transmitting the generated primary random access preamble to the base station; receiving a primary random access response including primary timing advance (TA) information from the base station; generating a secondary random access preamble based on the primary random access response; transmitting the secondary random access preamble to the base station based on the primary TA information; receiving a secondary random access response including secondary TA information from the base station; and transmitting a connection request to the base station at a transmission timing based on the primary TA information and the secondary TA information,
wherein the first random access preamble and the second random access preamble have different configurations.

The processor may further cause the terminal to perform:
in the generating of the primary random access preamble, if a length of an orthogonal frequency division multiplexing (OFDM) symbol for the primary random access preamble is n times a length of a cyclic prefix (CP) for the primary random access preamble, generating the primary random access preamble to have a structure repeated in units of the length of the CP, and
when the primary random access preamble is generated to have the structure repeated in units of the length of the CP, transmitting the primary random access preamble in subcarriers having indices (n×k) in a frequency domain of the OFDM symbol, wherein n is a natural number, and k is an integer.

The processor may further cause the terminal to perform:
in the generating of the primary random access preamble, if a length of an OFDM symbol for the primary random access preamble is not n times a length of a CP for the primary random access preamble, generating the primary random access preamble to have a structure in which the OFDM symbol is repeated in units of a greatest common divisor of a number of samples for the CP and a number of samples for the OFDM symbol, wherein n is a natural number.

The processor may further cause the terminal to perform:
in the generating of the secondary random access preamble, generating the secondary random access preamble by repeating an OFDM symbol for the secondary random access preamble twice in time, excluding a cyclic prefix for the secondary random access preamble.

### Advantageous Effects

According to exemplary embodiments of the present disclosure, in a mobile communication network with a cell size of 100 km or more in radius or when performing asynchronous grant-free uplink transmissions in which multiple users simultaneously use the same resources, initial (random) connection performance can be improved with minimal impact on the existing NR/LTE specifications, even in situations where GNSS information of terminals and ephemeris information of satellites are not available. Moreover, exemplary embodiments of the present disclosure can address the uncertainty in the uplink timing of a terminal that lacks its own location information in a satellite-based NTN. Furthermore, exemplary embodiments of the present disclosure can also resolve the issue of interference caused by reception timing mismatches at a base station.

### DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a sequence chart illustrating an initial access procedure of the 3GPP NR/LTE.

FIG. 5A is a conceptual diagram for describing a time difference of initial access preambles based on distances in the 3GPP LTE.

FIG. 5B is a conceptual diagram for comparing and describing initial access preamble formats.

FIG. 6A is a conceptual diagram illustrating a distance between a satellite and a terminal in an NTN.

FIG. 6B is a conceptual diagram illustrating a difference in propagation delay times according to locations of a satellite and a terminal within a spot beam coverage.

FIG. 7 is a conceptual diagram illustrating an example in which a random access preamble is transmitted.

FIG. 8 is a sequence chart illustrating the four-step random access procedure specified in the 3GPP specifications.

FIG. 9A is a conceptual diagram illustrating indices of subcarriers in which a signal is transmitted among subcarriers within a preamble.

FIG. 9B is a conceptual diagram illustrating a structure having a time-domain repeated structure in preamble symbols.

FIG. 10 is a conceptual diagram illustrating a structure of a random access preamble with a subcarrier spacing of 15 kHz in the NR system.

FIG. 11A is a conceptual diagram illustrating indices of subcarriers through which a signal is transmitted within a random access preamble.

FIG. 11B is a conceptual diagram illustrating a configuration having a time-domain repeated structure in random access preamble symbols.

FIG. 12A is a conceptual diagram for describing a case in which no inter-carrier interference exists when a preamble is received at a base station.

FIG. 12B is a conceptual diagram for describing a case where some inter-carrier interference exists when a preamble is received at a base station.

FIG. 13 is a conceptual diagram for describing a case where a base station predicts a transmission delay timing while moving a DFT window by a CP length.

FIG. 14A is a conceptual diagram illustrating indices of subcarriers through which a signal is transmitted within a random access preamble.

FIG. 14B is a conceptual diagram illustrating a structure of a repeated preamble within one OFDM symbol.

FIG. 15 is a conceptual diagram for describing a timing at which a secondary random access preamble is received at a base station.

FIG. 16 is a sequence chart illustrating a random access procedure when using a secondary random access preamble.

FIG. 17 is a flowchart for describing operations of a terminal during a 6-step random access procedure according to the present disclosure.

FIG. 18 is a flowchart for describing operations of a base station during a 6-step random access procedure according to the present disclosure.

FIG. 19 is a conceptual diagram for describing transmission timings of the primary PRACH preamble and the secondary PRACH preamble based on the 6-step random access procedure according to the present disclosure.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), and/or a 5G communication network (e.g. new radio (NR) communication network). The 4G communication network and 5G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

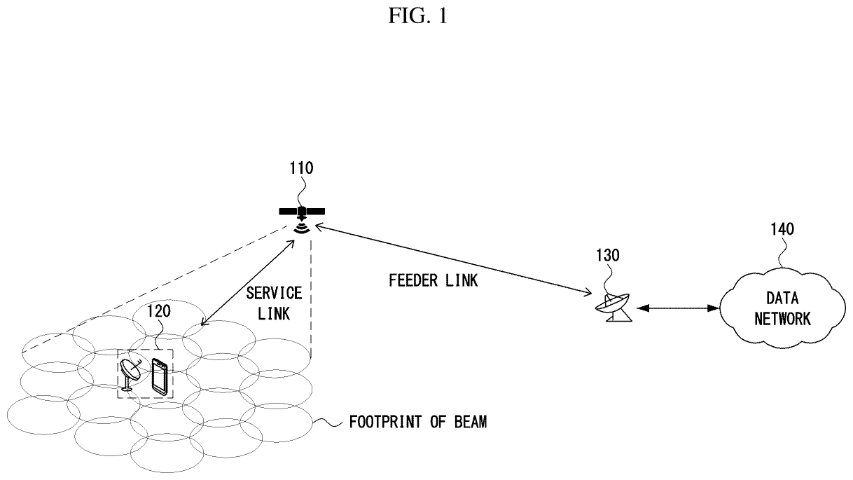

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

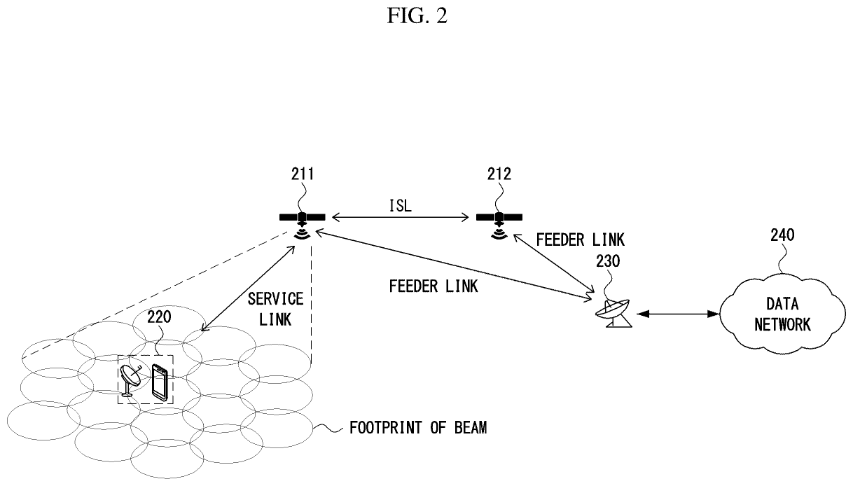

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

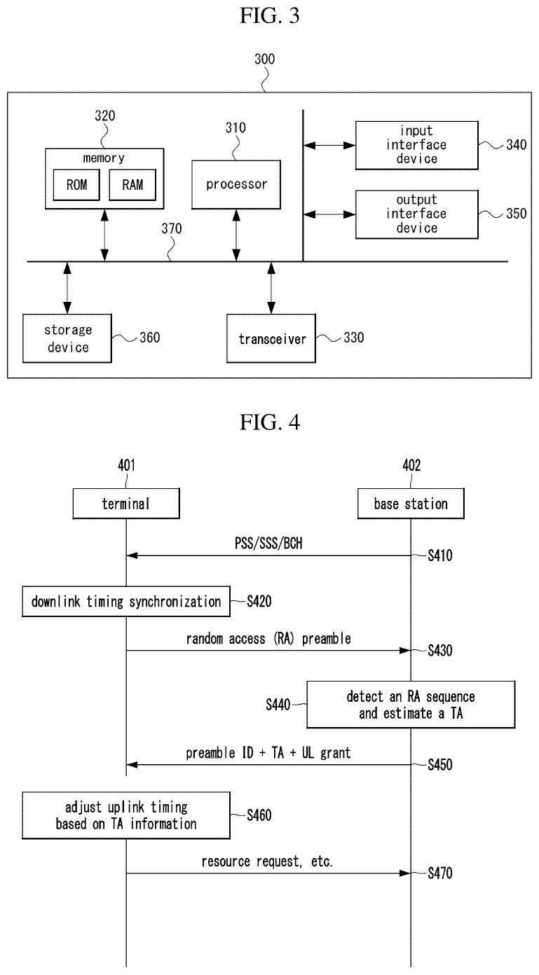

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum | <6 GHz (e.g. 2 GHz) | |
| (service link) | >6 GHz (e.g. DL 20 | |
| | GHZ, UL 30 GHz) | |
| Maximum channel | 30 MHz for band <6 GHz | |
| bandwidth capability | 1 GHz for band >6 GHz | |
| (service link) | | |
| Maximum distance between | 40,581 km | 1,932 km (altitude |
| satellite and communication | | of 600 km) |
| node (e.g. UE) at the | | 3,131 km (altitude |
| minimum elevation angle | | of 1,200 km) |
| Maximum round trip | Scenario A: 541.46 ms | Scenario C: (transparent |
| delay (RTD) (only | (service and feeder links) | payload: service and |
| propagation delay) | Scenario B: 270.73 ms | feeder links) |
| | (only service link) | −5.77 ms (altitude |
| | | of 60 0 km) |
| | | −41.77 ms (altitude |
| | | of 1,200 km) |
| | | Scenario D: (regenerative |
| | | payload: only service link) |
| | | −12.89 ms (altitude |
| | | of 600 km) |
| | | −20.89 ms (altitude |
| | | of 1,200 km) |
| Maximum delay variation | 16 ms | 4.44 ms (altitude |
| within a single beam | | of 600 km) |
| | | 6.44 ms (altitude |
| | | of 1,200 km) |
| Maximum differential | 10.3 ms | 3.12 ms (altitude |
| delay within a cell | | of 600 km) |
| | | 3.18 ms (altitude |
| | | of 1,200 km) |

| | |
|---|---|
| Service link | NR defined in 3GPP |
| Feeder link | Radio interfaces defined in |
| | 3GPP or non-3GPP |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C | D |
| Satellite | 35,786 km | | 600 km | |
| altitude | | | | |
| Maximum RTD | 541.75 ms | 270.57 ms | 28.41 ms | 12.88 ms |
| in a radio | (worst case) | | | |
| interface | | | | |
| between base | | | | |
| station and UE | | | | |
| Minimum RTD | 477.14 ms | 238.57 ms | 8 ms | 4 ms |
| in a radio | | | | |
| interface | | | | |
| between base | | | | |
| station and UE | | | | |

Meanwhile, the present disclosure will describe a structure of an initial (random) access channel and an initial (random) access method in a satellite cell of an NTN or an NR cell with a cell size of 100 km or more in radius. In particular, the present disclosure will describe a structure of an initial (random) access channel and an initial (random) access method for an NR-based mobile communication system supporting asynchronous, grant-free, and non-orthogonal multiple access scheme, in situations where GNSS information of terminals and ephemeris information of satellites are not available. In addition, exemplary embodiments of the present disclosure will describe initial (random) access techniques in an NTN with a cell size of 100 km or more, such as a GEO satellite cell with a cell radius of about 1000 km and an LEO satellite cell with a cell radius of 200 km or more.

The post-5G mobile communication networks are expected to evolve toward combining or cooperating a terrestrial network (TN) with a satellite network (e.g. non-terrestrial network (NTN)). In this satellite/terrestrial integrated system, commonality between satellite and terrestrial radio interfaces should be considered very important when considering costs of the terminal. Accordingly, NR-based NTN standardization is currently actively underway in the 3GPP. The NTN, as opposed to TN, needs to account for characteristics such as long round-trip delay, latency variations among terminals, large cell coverage, significant Doppler shifts between base stations and terminals, and constrained power environment typically found in satellite configurations. Based on these considerations, standardization and research on NTN radio interfaces, utilizing NR/LTE/NB-IoT technologies, are underway within the framework of 3GPP standards.

Furthermore, to enhance cell capacity and support a larger number of terminals concurrently within the constraints of limited frequency resources, research on non-orthogonal multiple access techniques is actively progressing, which belong to a fundamental technology for future-generation mobile communications beyond 5G, enabling simultaneous transmission of signals for multiple users over the same time, frequency, and spatial resources to enhance spectral efficiency.

Meanwhile, in order to assist the terminal's cell search in a process of acquiring synchronization with a cell in the network, two special signals including a primary synchronization signal (PSS) and a secondary synchronization signal (SSS) are transmitted in NR/LTE downlink. Within one cell, two PSSs within one synchronization signal block (SSB) are identical to each other. In addition, a PSS of one cell may have one of three different values depending on a physical layer cell identifier (ID) of the cell. More specifically, each of the three cell IDs within one cell ID group corresponds to a different PSS.

Meanwhile, a basic requirement in any cellular system is that the terminal needs to be able to request establishment of a connection to the network through a process commonly called random access. In the LTE/NR system, initial access or random access is used for several purposes. In the following description, initial access and random access may be used with the same meaning and may be used interchangeably. In addition, an initial access preamble and a random access preamble have the same meaning and may be used interchangeably.
Purpose of establishing a radio link as initial access (transition from RRC_IDLE to RRC_CONNECTED)
Purpose of re-establishing a radio link after a radio link failure
Purpose of acquiring uplink synchronization with a new cell through handover
Purpose of acquiring uplink synchronization when uplink or downlink data arrives in case that the terminal is in the RRC_CONNECTED state but uplink synchronization is not acquired
Purpose of making a scheduling request when there is no scheduling request resource designated on a physical uplink control channel (PUCCH)

In all of the above cases, the main goal is to acquire uplink synchronization during initial access. In addition, the random access process also serves a purpose of assigning a unique identifier, C-RNTI, to the terminal.

Meanwhile, the main purpose of preamble transmission is to inform the base station that there is a random access attempt from the terminal and to enable the base station to estimate a delay time between the terminal and the base station (location of the terminal from the cell or base station). The estimated delay may be used to adjust an uplink timing so that all terminals' uplink signals are simultaneously received at the base station. A time-frequency resource in which the initial access preamble is transmitted is called a physical random access channel (PRACH). The network broadcasts to all terminals which time-frequency resources can be used to transmit the initial access preamble. In an initial access process, the terminal selects one preamble to be transmitted on a PRACH.

The length of a region of a preamble in the time domain varies depending on a configuration of the preamble. A basic initial access resource has a length of 1 ms, but a longer preamble may be configured. In addition, theoretically, an uplink scheduler of the base station may secure an arbitrarily long initial access region by simply avoiding scheduling terminals in a plurality of consecutive subframes. FIG. 4 is a sequence chart illustrating an initial access procedure of the 3GPP NR/LTE.

Referring to FIG. 4, a base station 402 may broadcast PSS/SSS/broadcast channel (BCH) within a coverage of the base station 402 in step S410. Accordingly, a terminal 401 located within the coverage of the base station 402 may receive the PSS/SSS/BCH in step S410.

In step S420, the terminal 401 may acquire synchronization based on the received PSS/SSS and obtain system information from the received BCH. Information included in the BCH transmitted by the base station 402 may include parameters for generating an RA preamble.

In step S430, the terminal 401 may generate an RA preamble based on the parameters included in the BCH, and transmit it to the base station 402. The base station 402 may receive the RA preamble transmitted by the terminal 401 in step S430.

In step S440, the base station 402 may detect a sequence included in the RA preamble received from the terminal 401 based on the RA preamble received from the terminal 401, and estimate a transmission timing of the terminal 401. The transmission timing of the terminal 401 estimated by the base station 402 may be timing advance (Timing_Advanced) information. Such estimation of the uplink timing is an essential procedure in the OFDM-based NR/LTE system, and if uplink synchronization is not acquired between the base station 402 and the terminal 401, uplink data cannot be transmitted.

In step S450, the base station 402 may deliver a preamble identifier (ID), timing advance (TA) information, and UL grant to the terminal 401 based on the RA preamble received from the terminal 401. Accordingly, the terminal 401 may receive the preamble ID, TA information, and UL grant from the base station 402 in step S450.

The initial access procedure described above may be divided into four steps as follows.

The first step may be a step in which the terminal 401 receives the PSS/SSS/BCH from the base station 402. The second step may be a step in which the terminal 401 transmits the RA preamble to the base station 402. The third step may be a step in which the base station 401 extracts the parameters from the RA preamble received from the terminal 401. The fourth step may be a step in which the base station 401 transmits the preamble ID, TA information, and UL grant to the terminal 401.

Based on the above procedure, in step S460, the terminal 401 may adjust the uplink timing based on the TA information received from the base station 402. In step S470, the terminal 401 may transmit a request for a resource to the base station 402 based on the adjusted uplink timing.

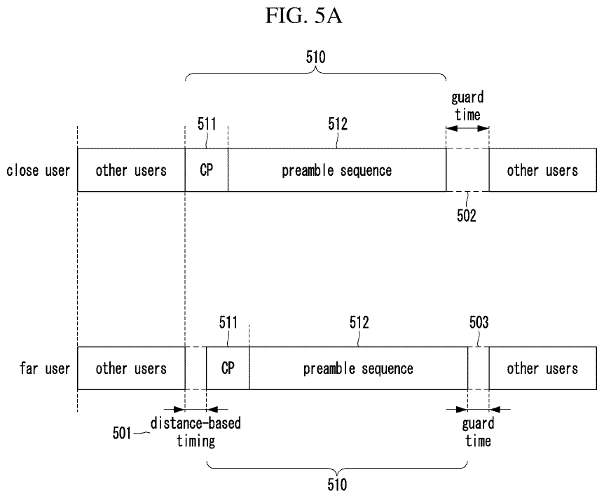

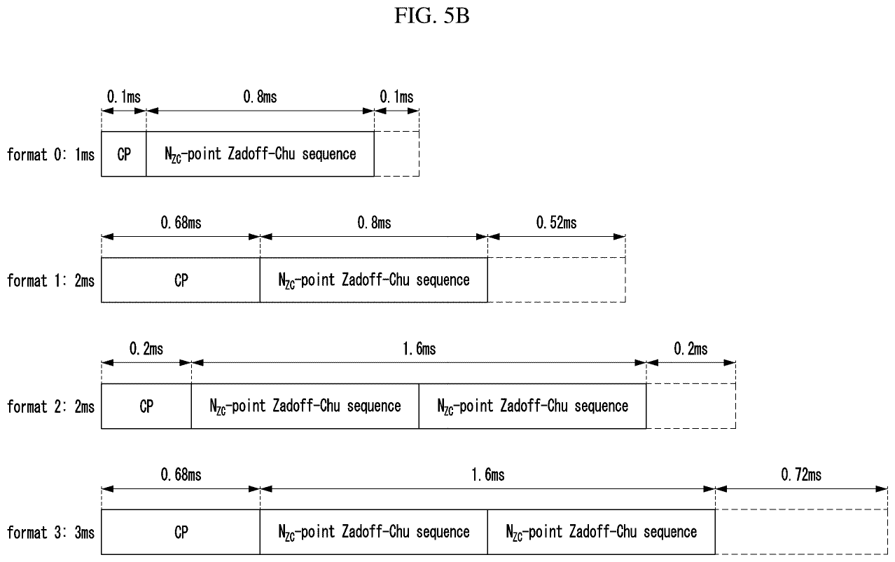

FIG. 5A is a conceptual diagram for describing a time difference of initial access preambles based on distances in the 3GPP LTE.

Referring to FIG. 5A, illustrated is a difference in arrival times of preambles of a user close to the base station and a user far from the base station.

First, an initial access preamble 510 defined in the initial access procedure is composed of a cyclic prefix (CP) 511, a preamble sequence 512, and guard time (GT) 502 or 503.

Referring to FIG. 5A, an arrival time of the CP 511 at the base station may vary based on a distance between the user and the base station. For example, in case of a distant user compared to a close user, the CP 511 may arrive at the base station with a difference of a distance-based timing 501. The distance-based timing 501 requires a longer time as the distance between the user and the base station increases. In addition, a time interval of the guard time 502 or 503 may vary based on the distance-based timing 501. The CP 511 is used to prevent inter-symbol interference (ISI) when signals are transmitted through distributed channels in the orthogonal frequency division multiplexing (OFDM) scheme. The CP is a duplication of a portion of the last part of the corresponding OFDM symbol.

The initial access preamble 510 illustrated in FIG. 5A may have four formats, as illustrated in FIG. 5B.

FIG. 5B is a conceptual diagram for comparing and describing initial access preamble formats.

In FIG. 5B, an initial access preamble of format 0 may have a total length of 1 millisecond (ms), and it may have a CP of 0.1 ms, a preamble sequence of 0.8 ms, and a GT of 0.1 ms. The format 0 may support a case where the coverage of the base station is within 15 km.

An initial access preamble of format 1 may have a total length of 2 ms, and may have a CP of 0.68 ms, a preamble sequence of 0.8 ms, and a GT of 0.52 ms. The format 1 may support a case where the coverage of the base station is within 78 km.

An initial access preamble of format 2 may have a total length of 2 ms, and may have a CP of 0.2 ms, a preamble sequence of 1.6 ms, and a GT of 0.2 ms. The format 2 may support a case where the coverage of the base station is within 30 km.

An initial access preamble of format 3 may have a total length of 3 ms, and may have a CP of 0.68 ms, a preamble sequence of 1.6 ms, and a GT of 0.72 ms. The format 3 may support a case where the coverage of the base station is within 100 km.

In the format 2 and format 3 discussed above, the preamble sequence is transmitted repeatedly twice. A reason the preamble sequence is repeated twice is to increase energy gain.

The GT may be used to handle a timing uncertainty in preamble transmission. Before starting the initial access procedure, the terminal may acquire downlink synchronization from the cell search process. However, if uplink synchronization is not yet acquired, the location of the terminal within the cell is unknown. Therefore, uncertainty may still exist in the uplink timing. As the cell size increases, the uncertainty in the uplink timing may also increase. The GT may be used as a portion of preamble transmission to consider the timing uncertainty and avoid interference with subsequent subframes that are not used for initial access. For this purpose, the GT needs to be defined as a value greater than a sum of a difference in round-trip delay times of a terminal closest to the base station (e.g. eNodeB) and a terminal farthest from the base station and a multipath channel delay time. For the format 4, which has the longest GT, a cell radius of 100 km or less is being considered.

Therefore, in case of a mobile communication network with a cell size of 100 km or more, such as NTN, the existing preamble formats cannot solve the problems of uplink timing uncertainty and interference to subsequent subframes.

Table 4 below shows initial access preamble formats in the NR system.

TABLE 4

| | | | | | Preamble |
|---|---|---|---|---|---|
| | Preamble | Subcarrier | Number | CP | length |
| | sequence | spacing | of | length | (us) (excluding |
| Format | length | (kHz) | repetitions | (us) | CP) |
| 0 | 839 | 1.25 | 1 | 103.12 | 800 |
| 1 | 839 | 1.25 | 2 | 684.37 | 1600 |
| 2 | 839 | 1.25 | 4 | 152.60 | 3200 |
| 3 | 839 | 5 | 4 | 103.12 | 800 |
| A1 | 139 | 15 | 2 | 9.37 | 133.33 |
| A2 | 139 | 15 | 4 | 18.75 | 266.67 |
| A3 | 139 | 15 | 6 | 28.12 | 400 |
| B1 | 139 | 15 | 2 | 7.03 | 133.33 |
| B2 | 139 | 15 | 4 | 11.71 | 266.67 |
| B3 | 139 | 15 | 6 | 16.41 | 400 |
| B4 | 139 | 15 | 12 | 30.47 | 800 |
| C0 | 139 | 15 | 1 | 40.36 | 66.67 |
| C2 | 139 | 15 | 4 | 66.67 | 266.67 |

As shown in Table 4 above, the NR system also has difficulty in supporting a cell radius of more than 100 km, like the initial access preambles of the LTE system.

In addition, one of the reasons for including the CP in the initial access preamble of NR and LTE is that the complexity of frequency domain processing at the base station can be reduced by using the CP. As described above, by eliminating ISI at the base station, the base station can increase processing efficiency in the frequency domain.

To solve the ISI problem, the length of CP should be defined as a value greater than the difference in round-trip delay times of the terminal closest to the base station and the terminal at the farthest distance, and is preferably approximately the same as the length of GT.

By not scheduling any uplink transmission in a subframe following the random access resource, a larger guard period than that illustrated in FIGS. 5A and 5B may be generated. Therefore, in a case where the cell size is over 100 km, such as NTN, the difference in round-trip delay times of the terminals exceeds the length of CP, making frequency domain processing through a single Fast Fourier Transform (FFT) window impossible. In other words, time domain processing should be performed through multiple FFT windows. This causes problems in that receiver complexity and preamble acquisition time become longer.

In addition, when the NOMA technology, which is being considered as a core technology for next-generation mobile communication, is applied to the LTE or NR system, signals of users using the same resources at the same time are separated after FFT processing on OFDM reception signals not only in the power-domain NOMA scheme but also in the code-domain NOMA scheme, OFDM symbol-level synchronization is essentially required.

On the other hand, as a method to solve the issues described above, a synchronous grant-based transmission method, in which terminals know their own location information through GNSS receivers, and based on the location information, uplink timings are predetermined to enable simultaneous receptions at the base station within a CP length, may be used. The synchronous grant-based transmission method has the advantage of being able to reuse the existing NR/LTE preambles as they are. However, not only is it difficult for all terminals to have GNSS reception capabilities in all situations, but asynchronous grant-free based transmission may also be required depending on a service. Therefore, a random access method and preamble design for terminals without GNSS reception capabilities or in asynchronous grant-free situations are essentially required.

In order to solve these problems, the present disclosure will describe details for providing an initial access channel and an access method using the same, which are applicable to a mobile communication network having a wide cell coverage such as NTN under an asynchronous grant-free situation where a plurality of users use the same resources simultaneously, while minimizing the impact on the existing NR/LTE specifications. In addition, the present disclosure will describe details for providing an initial access channel and an access method applicable to a mobile communication network with a NOMA environment while minimizing the impact on the existing NR/LTE specifications.

The present disclosure provides an initial access channel and an initial access method having minimum impact on the existing NR/LTE specifications in situations where GNSS information of terminals and ephemeris information of satellites are not available, in the case of asynchronous grant-free uplink transmission in a mobile communication network with a cell size of 100 km or more in radius or in which multiple users simultaneously use the same resources.

In particular, it provides an initial access channel and an initial access method in the NR/LTE-based mobile communication system to improve initial access performance.

First, the present disclosure provides a method for reducing uncertainty in uplink timing caused by a terminal not knowing its own location information when applying an NTN based on a satellite such as GEO or LEO to the existing terrestrial NR/LTE system.

Second, the present disclosure provides a preamble structure applying a repeated structure suitable for asynchronous grant-free uplink transmission in a mobile communication network such as NTN with a large cell radius.

Third, the present disclosure provides a method for solving a problem of interferences at the base station, which are caused by asynchronous grant-free uplink transmissions from a plurality of non-GNSS terminals without their location information, in a situation where a difference in round-trip delay times of terminals exceeds the length of CP in a mobile communication network such as NTN.

Fourth, the present disclosure provides a method for minimizing the impact on the existing NR/LTE specifications by introducing a repeated structure that fully utilizes a physical layer numerology of the existing NR/LTE.

Exemplary embodiments below will be described using an NR-based satellite mobile communication system. However, it should be noted that exemplary embodiments of the present disclosure are applicable to any other mobile communication system with a large cell coverage.

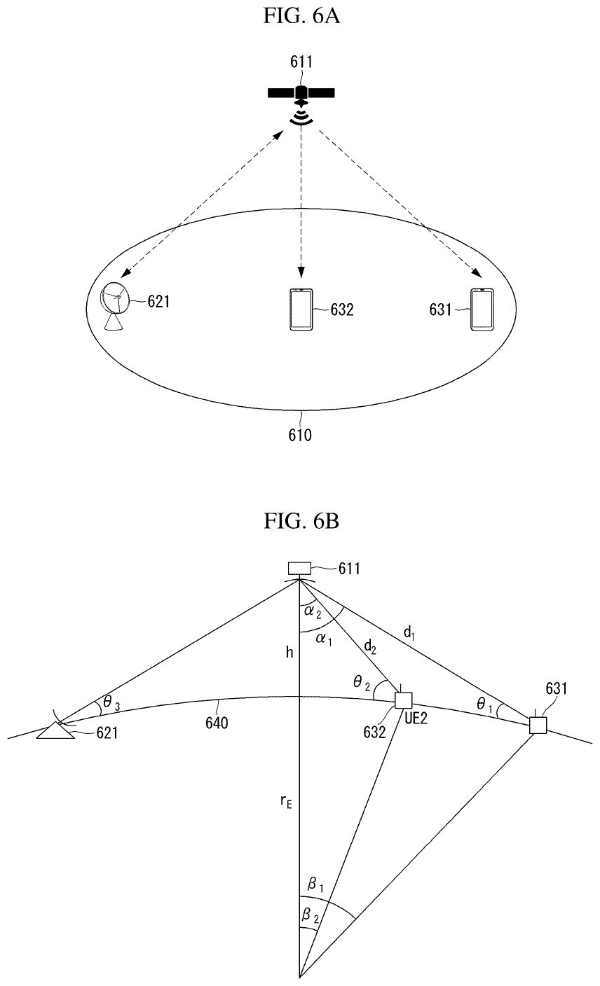

FIG. 6A is a conceptual diagram illustrating a distance between a satellite and a terminal in an NTN.

Referring to FIG. 6A, a satellite 611 may have a certain coverage 610 on the ground as a communication area. Terminals 631 and 632 located within the satellite's coverage 610 may perform wireless communication with the satellite 611. In addition, a terrestrial station 621 may also be referred to as a gateway, and may be a terrestrial node communicating with the satellite.

As illustrated in FIG. 6A, the NTN may have a network structure in which the terrestrial station 621 is connected to the terminals 631 and 632 on the ground through the satellite 611. Since the satellite 611 is located at a very high altitude above the ground, it has a fairly wide service area that is the coverage 610. In other words, the coverage 610 of the satellite 611 is so wide that it cannot be compared to a coverage of a general terrestrial base station. In this case, a distance between the second terminal 632, which is a terminal directly under the satellite, and the satellite 611 may correspond to the shortest distance from the satellite to the ground. In addition, a distance between the first terminal 631 located near an edge of the coverage 610 and the satellite 611 may correspond to the longest distance from the satellite to the ground. Therefore, a signal delay may occur depending on a difference between a distance from the satellite 611 to the second terminal 632 at the shortest distance and a distance from the satellite 611 to the first terminal 631 at the longest distance.

FIG. 6B is a conceptual diagram illustrating a difference in propagation delay times according to locations of a satellite and a terminal within a spot beam coverage.

Referring to FIG. 6B, the satellite 611, terminals 631 and 632, and terrestrial station 621 are illustrated as in FIG. 6A. In FIG. 6B, a ground surface 640 is additionally illustrated.

First, parameters illustrated in FIG. 6B will be described. A parameter h may be the satellite's height and may be a distance from the ground surface 640 to the satellite 611. A parameter rE may mean the Earth's radius, and a parameter d may mean a distance between the satellite and the terminal 631 or 632 (i.e. satellite-terminal distance). Specifically, d1 may be a distance between the first terminal 631 and the satellite 611, and d2 may be a distance between the second terminal 632 and the satellite 611. α may be an angle at which the terminal 631 or 632 is located with respect to a vertical plane from the satellite. Specifically, α1 may be an angle between the first terminal 631 and the satellite 611, and α2 may be an angle between the second terminal 632 and the satellite 611. β may be an angle at which the terminal 631 or 632 is located with respect to a vertical plane from the center of the Earth. Specifically, β1 may be ab angle at which the first terminal 631 is located with respect to the vertical plane from the center of the Earth, and β2 may be an angle at which the second terminal 632 is located with respect to the vertical plane from the center of the Earth. Finally, θ may be an elevation angle at the terminal or terrestrial station. Specifically, θ1 may be an elevation angle of the first terminal 631, θ2 may be an elevation angle of the second terminal 632, and θ3 may be an elevation angle of the terrestrial station 621.

Describing FIG. 6A using the parameters defined above, it may be assumed that the terrestrial station 621 and the first terminal 631 are located at an edge of the coverage 610 of the satellite 611, and the second terminal 632 is located in the innermost part of the largest spot beam coverage. In addition, propagation delay times of the first terminal 631 and the second terminal 632 with respect to the satellite 611 may be t1 and t2, respectively, and a difference Δt1,2 between the delay times may be obtained by Equations below.

Let θ1 be the minimum elevation angle and β1 be a satellite coverage angle. In addition, let α1,2 be a spot beam angle having the maximum size at a difference α1−α2 between an angle between the first terminal 631 and the satellite 611 and an angle between the second terminal 632 and the satellite 611. Let β1,2 be a spot beam coverage angle having the maximum size of a difference (β1−β2) between an angle at which the first terminal 631 is located with respect to a vertical plane from the center of the Earth and an angle at which the second terminal 632 is located with respect to the vertical plane from the center of the Earth.

Then, a relationship between the coverage angle and the elevation angle may be expressed as Equation 1 below.

$${β}_{i} = arccos ( \frac{{r}_{E}}{{r}_{E + h}} cos {θ}_{i} ) - {θ}_{i} \qquad [ Equation 1 ]$$

In Equation 1, i may indicate a terminal i within the spot beam coverage.

In addition, for the maximum spot beam, a spot beam coverage diameter s1,2 along the ground surface may have a relationship with the maximum spot beam coverage angle β1,2 as shown in Equation 2 below.

$${s}_{1 , 2} = 2 π {r}_{E} \frac{{β}_{1 , 2}}{360 °} \qquad [ Equation 2 ]$$

In addition, the distance between each terminal and the satellite has a relationship expressed in Equation 3 below.

$${d}_{i =} \sqrt{( {r}_{E}^{2} + {( {r}_{E} + h )}^{2 )} - 2 {r}_{E} ( {r}_{E + h} ) cos {β}_{i}} \qquad [ Equation 3 ]$$

In Equation 3, i may indicate the terminal i within the spot beam coverage.

Given the altitude h, minimum elevation angle θ1, beam coverage diameter s1,2, and Earth radius rE, the distance d between the satellite and the terminal may be calculated as in Equation 3 from the above equations. If the distance d between the satellite and the terminal is calculated as shown in Equation 3, a propagation delay time ti may be expressed as Equation 4 below.

$${t}_{i} = \frac{{d}_{i}}{c} \qquad [ Equation 4 ]$$

Also in Equation 4, i may indicate the terminal i within the spot beam coverage, and c may be a speed of electromagnetic waves.

Based on Equation 4 above, a difference in propagation times between two terminals within the spot beam coverage may be calculated as Equation 5 below.

$$Δ {t}_{1 , 2} = {t}_{1} - {t}_{i} \qquad [ Equation 5 ]$$

The difference in propagation times shown in Equation 5 may vary depending on the satellite's altitude and the spot beam coverage. Therefore, an elevation angle of 40, considering a GEO satellite currently being considered for NTN and Korea, should be taken into consideration.

Meanwhile, as described above, the random access channel format 1, which supports the largest cell in the current NR system, can support up to a 100 km cell radius of a terrestrial mobile communication system. However, in case of the NTN system, there is a problem that it can only support up to a cell radius of 75 km. In case of the NTN system, overall system capacity can be maximized by making a multi-beam as small as possible. In addition, the smaller the CP and GT lengths in the random access channel, the more data transmission capacity can be increased. Considering these points, it is efficient to make the satellite's beam smaller.

Therefore, in the NR-based NTN, a random access channel needs to consider a cell size and a low elevation angle of a GEO satellite and LEO satellite, which can be realistically considered in terms of current satellite antenna technology and system capacity. In addition, when a satellite base station in a GEO satellite system has a 500 km cell size, a difference in round trip delay times between the nearest terminal and the farthest terminal is up to 3.26 ms. In addition, when a satellite base station in a LEO satellite system has a maximum cell size of 200 km, a difference in round-trip delay times between the nearest terminal and the farthest terminal is up to 1.308 ms. In order to solve the problem of increased round-trip delay time in the NTN, an appropriate CP should be provided. Of course, as the cell size increases, the difference in round-trip delay times becomes larger and a CP of a larger length will be required accordingly.

When terminals on the ground simultaneously transmit uplink signals to the terrestrial station through the satellite, the signals actually arrive at the satellite at different times due to such the large difference in delay times. In addition, the difference in arrival times may act as a burden on system operations, such as requiring a larger CP length and guard period. In a situation where a location of a terminal performing UL attempt is not known, there is an inefficiency in that the satellite base station should continue to wait for signals until a time when signals from all terminals are expected to arrive.

In such the environment, a terminal desiring to obtain information on a base station based on a downlink signal transmitted through the satellite via the terrestrial station should identify an initial access period (more accurately, time-frequency resources) when attempting to establish a communication link with the satellite base station. Additionally, the terminal should transmit an initial access request signal to the satellite base station during that period. This series of processes is called the initial access process. In this process, in determining the initial access period for transmitting the initial access preamble for initial access, the difference in the arrival delay times of uplink signals becomes an important factor.

Therefore, in order to solve the problem caused by the difference in arrival delay times of uplink signals as above, the present disclosure proposes a new initial access method considering the NTN system or successor system operating based on the 5G NR/LTE.

According to the existing NTN specifications, the following method was used to overcome the problem of the difference in arrival delay times due to the distance differences between the satellite and the terminals.

First, it is assumed that all terminals know their locations through GNSS receivers.

Second, it is assumed that the satellite's location can also be known through system information of the downlink signal.

Based on the above two assumptions, the existing NTN allows each terminal to determine a transmission timing of its uplink random access signal by considering a delay time of a terminal expected to be at the farthest distance from the satellite.

In the 5G NR/LTE system, a portion of a frequency-time region in the middle of the entire OFDM frame is generally used as a resource for initial access. There are various types of random access preambles used in the NR/LTE system.

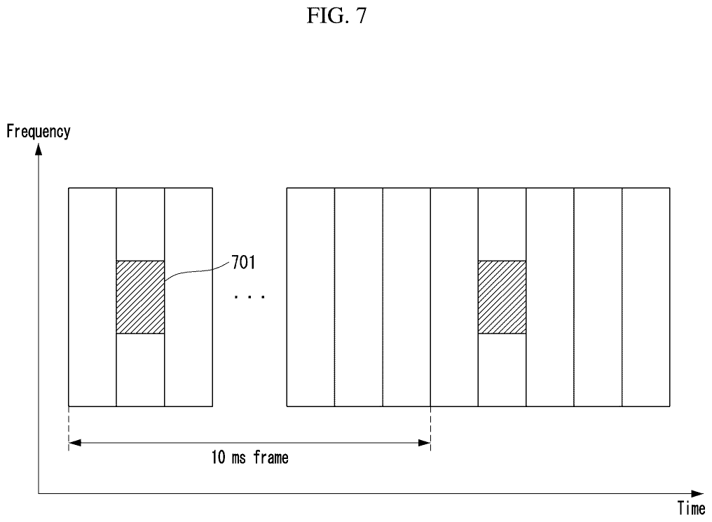

FIG. 7 is a conceptual diagram illustrating an example in which a random access preamble is transmitted.

Referring to FIG. 7, the horizontal axis represents time, and the vertical axis represents frequency. In addition, a 10 ms frame may include a plurality of subframes. A preamble 701 may be transmitted in a time-frequency resource (i.e. PRACH) of the plurality of subframes, which is configured by higher layer signaling. Downlink data may be transmitted in time-frequency resources in which the preamble is not transmitted in the plurality of subframes.

The procedure in which the terminal transmits a random access preamble to the base station and the base station obtains information on an uplink timing of the terminal may be referred to as a random access procedure. In the 5G NR system, the random access procedure may be defined as a four-step random access procedure and a two-step random access procedure according to the technical specifications. The general four-step random access procedure among the four-step random access procedure and the two-step random access procedure will be described below.

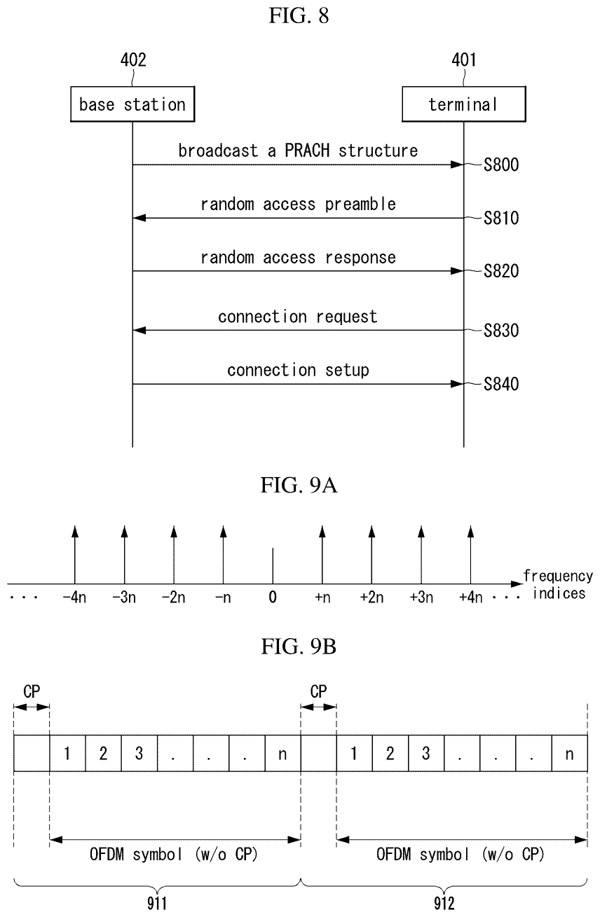

FIG. 8 is a sequence chart illustrating the four-step random access procedure specified in the 3GPP specifications.

Referring to FIG. 8, the terminal 401 and the base station 402 in FIG. 8 will use the same reference numerals as described in FIG. 4.

Referring to FIG. 8, in step S800, the base station 402 may broadcast information on a PRACH structure. The step S800 is not included in the four-step random access procedure, but may be a step that needs to be performed before the random access procedure. Therefore, not only step S800 but also the overall operations performed before the random access procedure between the base station 402 and the terminal 401 will be described briefly.

The base station 402 may perform downlink synchronization through SSB(s) transmitted for downlink. In other words, the terminal 401 that receives the SSB(s) transmitted by the base station 402 may perform downlink synchronization with the base station 402. The terminal 401 may receive a master information block (MIB) and a system information block (SIB) from the base station 402. The terminal 401 may collect information on a cell by demodulating the MIB/SIB. The terminal 401 may perform uplink synchronization based on the information collected by demodulating the MIB/SIB.

The general random access procedure may correspond to steps S810 to S840 described below. In step S810, the terminal 401 may transmit a random access preamble to the base station 402. Accordingly, the base station 402 may receive the random access preamble from the terminal 401 in step S810. In step S820, the base station 402 may transmit a random access response to the terminal 401. The terminal 401 receiving the random access response transmitted by the base station 402 may transmit a connection request to the base station 402 in step S830. The base station 402 receiving the connection request in step S830 may transmit a connection setup to the terminal 401 in step S840.

The four-step random access procedure may be achieved through the steps described above. In addition, the responses, request, and/or setup described in FIG. 8 may be transmitted as specific messages or signals.

The present disclosure proposes a process for random access in a satellite communication network under a situation where there are no GNSS information of the terminal and ephemeris information of the satellite, and proposes a random access preamble therefor.

As shown in FIG. 7 described above, the random access channel (PRACH) utilizes a resource of a portion of the entire uplink frame. Therefore, if a structure of the OFDM symbol, such as resources for other physical channels, can be utilized, efficient configuration of the overall frame may be possible.

Accordingly, in the present disclosure, an OFDM symbol may be designed to have a repeated structure therewithin while utilizing a structure of other physical channels used in the NR/LTE system as it is.

(1) Preamble Structure for a Case where a Length of an OFDM Symbol is n Times a CP Length

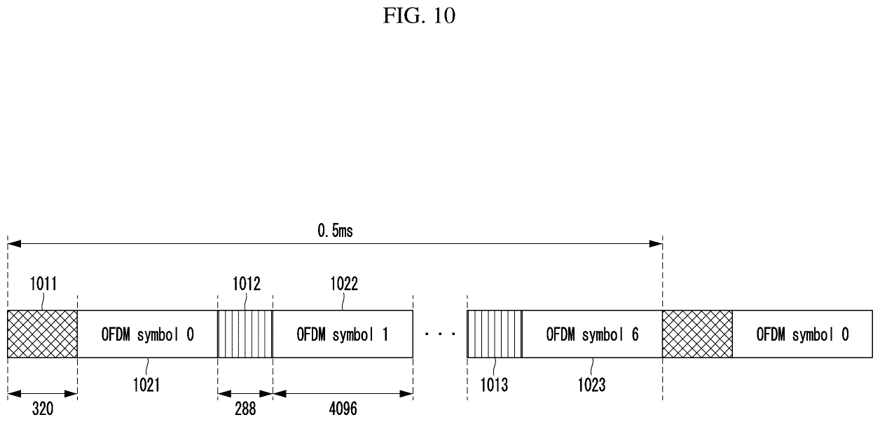

FIG. 9A is a conceptual diagram illustrating indices of subcarriers in which a signal is transmitted among subcarriers within a preamble, and FIG. 9B is a conceptual diagram illustrating a configuration having a time-domain repeated structure in preamble symbols.

First, referring to FIG. 9A, the horizontal axis represents frequency indices. As illustrated in FIG. 9A, only subcarriers having indices of ±(k×n) (e.g. k=0, 1, 2, . . . ) in the frequency domain may be utilized for transmission of a preamble. No signal is transmitted in subcarriers having the remaining indices. In other words, the subcarrier indices used to transmit the preamble are configured in advance, and zero (0) is input to the remaining subcarriers excluding than the preconfigured subcarriers, so that no signal is transmitted.

Then, referring to FIG. 9B, when the OFDM symbol length is n times the CP length (where n is a natural number), a signal having a structure that repeats n times within the OFDM symbol length may be generated. For convenience of implementation, a case where n is an exponent of 2 may be considered. That is, OFDM symbols constituting the random access preamble may be configured to repeat in units of the CP length.

As shown in FIG. 9B, to generate the preamble with the structure repeating n times in the time domain, only subcarriers with preconfigured indices may be used in the frequency domain, as previously described in FIG. 9A.

In the case of the structure of FIG. 9B, when considering the CP, a random access preamble with a structure repeating (n+1) times may be generated. In order to improve random access performance when the cell size is large or a received signal strength is weak, multiple OFDM symbols may be used to configure a random access preamble of a desired length. Referring again to FIG. 9B, a continuous form of random access preambles 911 and 912 each having a structure repeated (n+1) times and including a CP may be used. That is, it may have a structure in which the second random access preamble 912 is connected consecutively after the first random access preamble 911. By concatenating preambles each including the CP as described above, a random access preamble may be configured so that a total preamble length thereof becomes a desired length.

In the following description, for convenience of description, each random access preamble 911 or d 912 including the CP and having a structure repeated (n+1) times will be referred to as a preamble element. In addition, a random access preamble having a desired length, which is configured by concatenating the preamble elements, will be referred to as a connected preamble.

Meanwhile, based on one random access preamble element, several different random access preamble elements may be generated by mapping different values to subcarriers with indices of ±(k×n) (i.e. k=0, 1, 2, . . . ) for terminal identification. For example, a random access preamble element using only k values of 1, 2, and 3 and a preamble element using only k values of 1, 2, 3, and 4 may be identified from each other. Additionally, a preamble element using only k values of 1, 3, and 5 may also be identified from the above two preamble elements. In the above-described manner, different types of random access preamble elements may be generated by using various combinations of k values.

The terminal may generate a connected preamble by selecting one of the random access preamble elements described above. Therefore, the terminal may transmit the connected preamble generated based on the selected preamble element to the base station in the random access procedure.

The current NR/LTE specifications require 64 random access preambles in one cell. Therefore, the number of preamble elements based on the method described in the present disclosure may exceed 64. In other words, the number of combinations of frequency indices may exceed 64. When the number of preamble elements exceeds 64, spreading codes used to distinguish users in the current NR/LTE specifications, such as Gold codes or Walsh Hadamard codes with a length of 64 or more, may be further utilized to generated different random access connected preambles.

In addition, when the length of the random access connected preamble is long, that is, when the number of repetitions of preamble elements increases, if the number of subcarriers used for signal transmission is small, NOMA codes used for user discrimination in the existing NOMA scheme, such as SCMA, may be utilized.

(2) Preamble Structure for a Case where an OFDM Symbol Length is not n Times a CP Length

Hereinafter, a preamble structure when the OFDM symbol length is not twice or an integer multiple of the CP length.

FIG. 10 is a conceptual diagram illustrating a structure of a random access preamble with a subcarrier spacing of 15 kHz in the NR system.

Referring to FIG. 10, a case of a numerology 0 with a subcarrier spacing of 15 kHz is illustrated. Seven OFDM symbols 1021, 1022, . . . , and 1023 and CPs 1011, 1012, . . . , and 1012 respectively corresponding to the OFDM symbols are illustrated within 0.5 ms which is the length of one sub-slot.

The CP 1011 of the OFDM symbol 0 1021 may have 320 samples, and the CP of each of the OFDM symbol 1022 to the OFDM symbol 1023 may have 288 samples. In addition, the number of samples of one OFDM symbol may be 4096.

As illustrated in FIG. 10, in the case of the numerology is 0 with a subcarrier spacing of 15 kHz, the OFDM symbol length may not be twice or an integer multiple of the CP length. Therefore, in the present disclosure, if the OFDM symbol length is not twice or an integer multiple of the CP length, repeatability may be achieved in units of the greatest common divisor of the number of samples for the OFDM symbol and the number of samples for the CP. Therefore, the greatest common divisor may be 32 for 320 which is the number of samples for the CP 1011 corresponding to the OFDM symbol 1021, 288 which is the number of samples for each of the CPs 1012 and 1013 for the OFDM symbols 1022 to 1023, and 4096 which is the number of samples of each of the OFDM symbols 1021, 1022, and 1023.

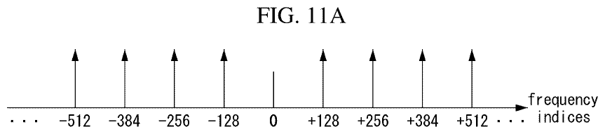

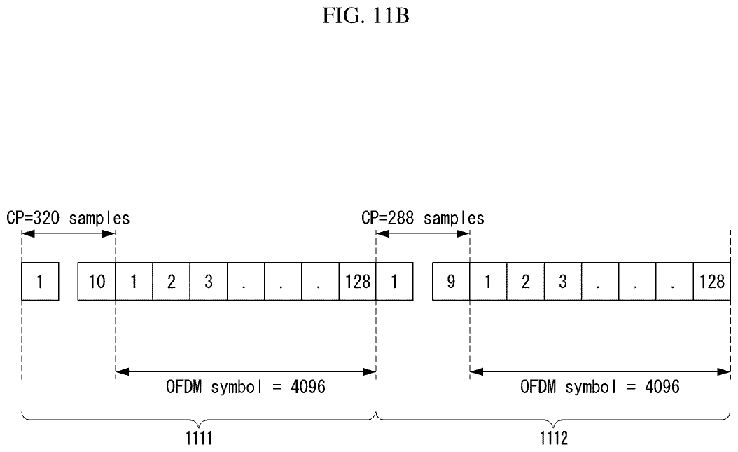

FIG. 11A is a conceptual diagram illustrating indices of subcarriers through which a signal is transmitted within a random access preamble, and FIG. 11B is a conceptual diagram illustrating a configuration having a time-domain repeated structure in random access preamble symbols.

First, referring to FIG. 11B, illustrated is a case configured to have repeatability in units of 32 samples, which is the greatest common divisor of the number of samples for the CP and the number of samples for the OFDM symbol. Since 320 samples can be transmitted in the first CP region, 32 samples may be repeated 10 times. In addition, since the OFDM symbol region consists of 4096 samples, 32 samples may be repeated 128 times. Since each of CPs other than the first CP consists of 288 samples, 32 samples may be repeated 9 times. Accordingly, as illustrated in FIG. 10, the first preamble 1111 including the CP in a sub-slot of 5 ms may have a form in which the same samples are repeated 138 times (i.e. 10+128=138), and each of other preambles from the second preamble 1111 including the CP may have a form in which the same samples are repeated 137 times (i.e. 9+128=137). When repeatability in units of 32 samples, which is the greatest common divisor, is configured as shown in FIG. 11B, the existing 3GPP NR/NTN numerology can be reused as is, and can be easily integrated into the existing NR/LTE frame structure.

Next, referring to FIG. 11A, the horizontal axis represents frequency indices. As illustrated in FIG. 11A, only subcarriers with indices that are multiples of 128 may be used to transmit a signal in the random access preamble. No signal may be transmitted in subcarriers with the remaining indices.

Here, 128 may be the repetition number p (p is a natural number) within the OFDM symbol illustrated in FIG. 11B. Therefore, in FIG. 11A, only subcarriers with indices corresponding to integer multiples of 128, such as ±128, ±256, ±384, ±512, which are frequency indices corresponding to integer multiples of the repetition number p within the OFDM symbol, may be used to transmit a signal in the random access preamble. Used for transmission. As described above, the subcarrier indices used to transmit the preamble are configured in advance, and zero (0) is input to the remaining subcarriers excluding than the preconfigured subcarriers, so that no signal is transmitted.

In the above, the operation from the perspective of a terminal transmitting a random access preamble has been described. When the terminal transmits the random access preamble described above, the base station should receive it and identify whether the preamble is received.

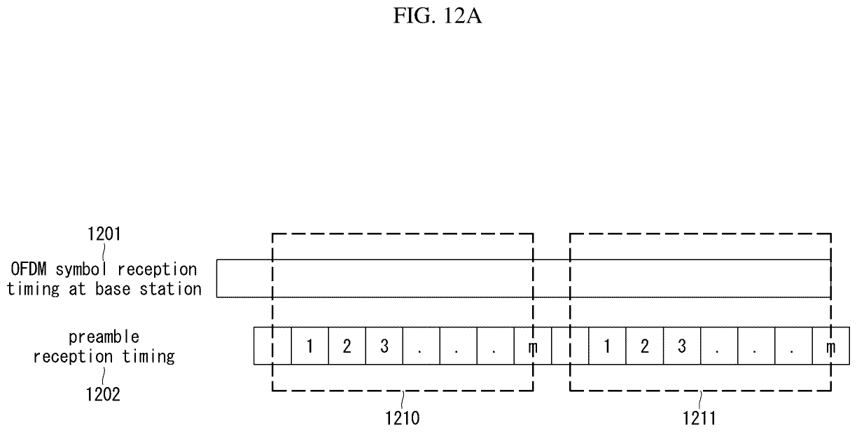

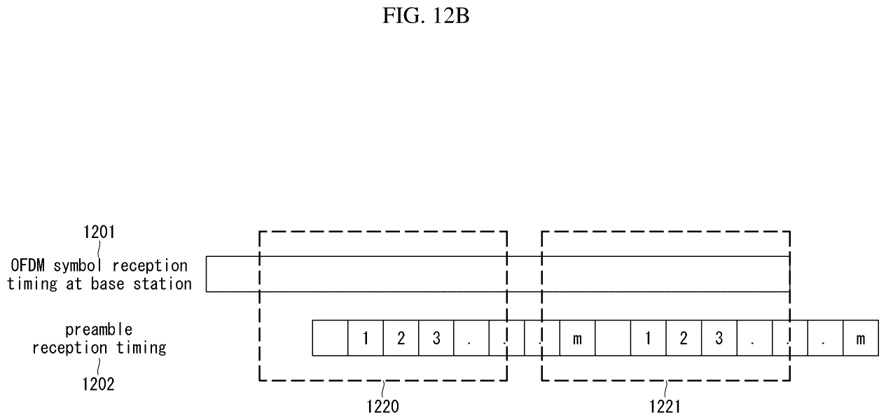

The situation in which the base station receives the random access preamble according to the present disclosure may be broadly classified into two cases depending on a reception timing of the preamble. Thies will be described with reference to FIGS. 12A and 12B.

FIG. 12A is a conceptual diagram for describing a case in which no inter-carrier interference exists when a preamble is received at a base station, and FIG. 12B is a conceptual diagram for describing a case where some inter-carrier interference exists when a preamble is received at a base station.

FIGS. 12A and 12B each illustrate timings of receiving random access preambles at a satellite when a terminal transmits random access preambles each consisting of two OFDM symbols to the satellite. The timings illustrated in FIGS. 12A and 12B may vary depending on a distance between the terminal and the satellite.

First, referring to FIG. 12A, it illustrates an OFDM symbol reception timing 1201 and a preamble reception timing 1202 at the base station. The OFDM symbol reception timing 1201 at the base station may mean a Discrete Fourier Transform (DFT) or Fast Fourier Transform (FFT) timing used by the base station to receive other uplink data and perform OFDM demodulation thereon. The preamble reception timing 1202 may refer to a timing at which the preamble transmitted by the terminal is received. In other words, it may mean a timing at which the preamble transmitted by the terminal at an arbitrary time point is received.

In FIG. 12A, the base station may receive the preambles using DFT windows or FFT windows 1210 and 1211 as illustrated in FIG. 12A at the OFDM symbol reception timing 1201. In the present disclosure, the base station may use either the DFT window(s) or FFT window(s). For convenience of description, the following description will be made assuming that the DFT windows 1210 and 1211 are used.

The example of FIG. 12A illustrates a case where the reception timing of the preamble is within a CP period. As illustrated in FIG. 12A, if the reception timing of the preamble is within a CP period, demodulation without inter-carrier interference (ICI) may be possible at the base station.

Referring to FIG. 12B, the OFDM symbol reception timing 1201 and the preamble reception timing 1202 at the base station are illustrated. In FIG. 12B, the DFT windows or FFT windows 1220 and 1221 are also illustrated. In FIG. 12B, either the DFT windows or the FFT windows may be used as described in FIG. 12A. For convenience of description, the description will be made assuming that the DFT windows 1220 and 1221 are used.

The example of FIG. 12B may correspond to a case where the preamble reception timing 1202 falls outside the CP period. As illustrated in FIG. 12B, a period from a start time to a certain time within first DFT window 1220 may be a period in which the CP and preamble are not received. On the other hand, a period from a start time to an end time within the second DFT window 1221 may be a period in which the preamble is received.

Since the preamble transmitted by the terminal is repeatedly transmitted in units of the CP or based on the greatest common divisor of the number of samples for the CP and the number of samples for the OFDM symbol constituting the preamble, even if one CP and an OFDM symbol corresponding thereto are not completely received in the second DFT window 1221 illustrated in FIG. 12B, one preamble may be recognized as having been received.

In other words, ICI may occur in the first DFT window 1221 because the first OFDM symbol is received in the middle of the window, which deteriorates the demodulation performance of the preamble. However, in the second DFT window 1221, demodulation can be performed without ICI due to the characteristics of the preamble according to the present disclosure. Therefore, the base station according to the present disclosure may know an approximate delay of the OFDM symbol of the random access preamble based on the demodulation performance of two consecutive OFDM symbols. In this case, the demodulation performance may also be identified based on a signal to interference plus noise ratio (SINR).

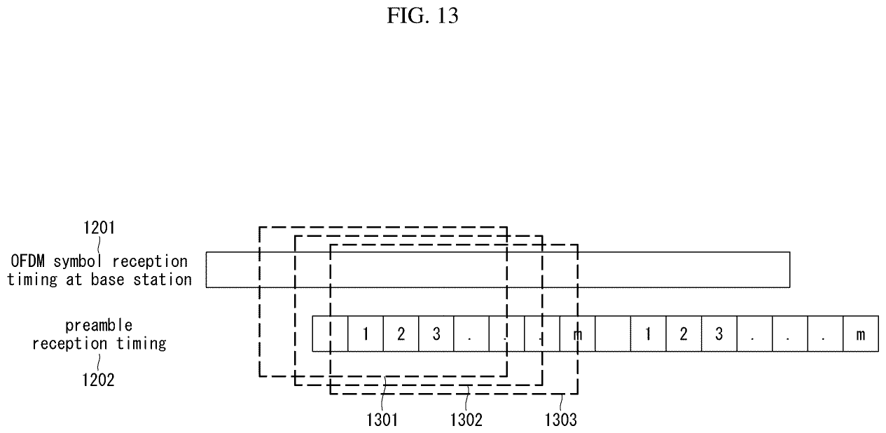

FIG. 13 is a conceptual diagram for describing a case where a base station predicts a transmission delay timing while moving a DFT window by a CP length.

In FIG. 13, the OFDM symbol reception timing 1201 and the preamble reception timing 1202 at the base station, which have been previously described in FIGS. 12A and 12B, will be used as they are. In addition, a DFT window 1301 may have the same form as the first DFT window 1221 previously described in FIG. 12B. In other words, FIG. 13 may correspond to a case that an OFDM symbol is received in the middle of the DFT window 1221. Further, FIG. 13 may correspond to a case where a coarse delay of the OFDM symbol of the random access preamble is identified based on the second DFT window 1221.

The base station may shift the DFT window by a CP length to accurately predict a delay of the OFDM symbol of the random access preamble. For example, after moving the DFT window to a position indicated by reference numeral 1302 by one CP length, the base station may identify whether ICI occurs in the frequency domain. If a SINR value is used to identify whether ICI occurs in the frequency domain, it may be identify by comparing a preset threshold with a SINR value in the shifted DFT window 1302. As described above, by moving the DFT window by a CP length, such as reference numerals 1301→1302→1303, a fine transmission delay in units of the CP may be predicted by identifying occurrence of ICI in the frequency domain (or through comparison with the threshold).

As described in FIG. 13, other methods rather than the method of predicting a timing using ICI information after OFDM demodulation may be used. For example, the timing may be estimated using correlation after filtering only a band corresponding to the PRACH.

Through the process described above, the base station may predict a transmission delay of a terminal performing random access and transmit to the terminal a command for adjusting a timing of the random access (Timing Advance (TA)) based on the predicted transmission delay. When the terminal receives the command for TA, an error of the next uplink transmission timing may be reduced to a unit of the CP or less.

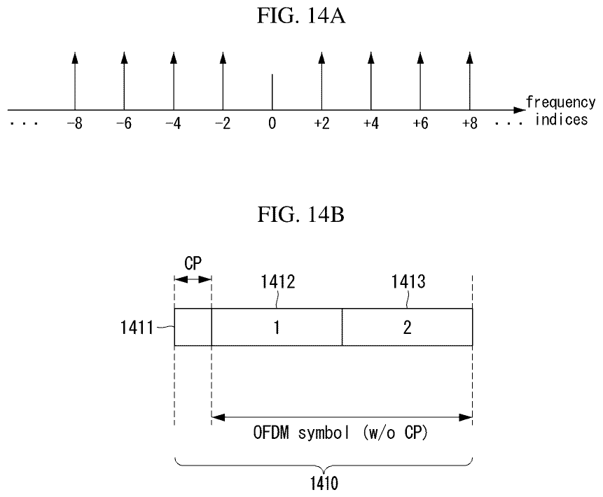

FIG. 14A is a conceptual diagram illustrating indices of subcarriers through which a signal is transmitted within a random access preamble, and FIG. 14B is a conceptual diagram illustrating a structure of a repeated preamble within one OFDM symbol.

The example of FIGS. 14A and 14B may correspond to a configuration of a secondary random access preamble for precise timing adjustment within a CP length after timing adjustment in units of a CP length has been previously performed.

Referring to FIG. 14A, the secondary random access preamble may be transmitted only in even subcarriers. When the secondary random access preamble is configured to be transmitted only in even subcarriers, it may have a form similar to the random access preamble previously described in FIG. 9A.

Although FIG. 14A illustrates the case where the secondary random access preamble is transmitted only in even subcarriers, but it may also be configured to be transmitted only in odd subcarriers. If configured to be transmitted only in odd subcarriers, it may be transmitted in subcarriers different from those for the random access preamble described above in FIG. 9A.

Referring to FIG. 14B, a random access preamble 1410 may be composed of a CP 1411 and an OFDM symbol having a structure repeated twice in the time domain. In the following description, for convenience of description, the first part of the OFDM symbol having a twice-repeated structure will be referred to as the first partial OFDM symbol 1412, and the second part thereof will be referred to as the second partial OFDM symbol 1413. Accordingly, the first partial OFDM symbol 1412 and the second partial OFDM symbol 1413 may have the same configuration.

The terminal may generate the secondary random access preamble based on the examples and descriptions in FIGS. 14A and 14B, and transmit the generated secondary random access preamble to the base station.

Then, a case where the base station receives the secondary random access preamble will be described.

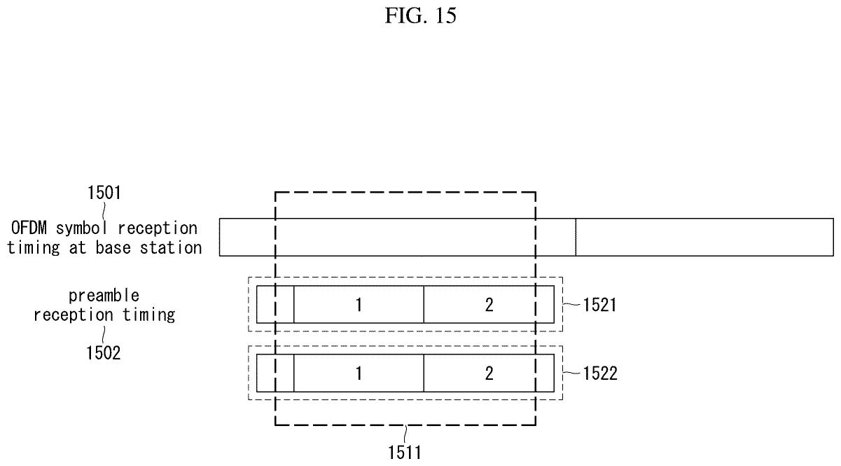

FIG. 15 is a conceptual diagram for describing a timing at which a secondary random access preamble is received at a base station.

In FIG. 15, illustrated are an OFDM symbol reception timing 1501 and a preamble reception timing 1502 at the base station, as previously described in FIG. 12A. Since the OFDM symbol reception timing 1501 and the preamble reception timing 1502 at the base station are the same as previously described in FIG. 12A, redundant descriptions will be omitted.

In addition, the base station may have a DFT window or FFT window used for OFDM demodulation. For convenience of description, the following description will also be made assuming that the base station uses a DFT window 1511.

Meanwhile, in the present disclosure, a secondary random access preamble may be a preamble received by the base station after the base station receives a primary random access preamble. In other words, the base station may be in a state of having already received the primary random access preamble. As described above, the base station may transmit a command for TA to the terminal based on receipt of the primary random access preamble. Therefore, the secondary random access preamble may be received with a timing adjusted within a CP period based on the command for TA.

As illustrated in FIG. 15, the secondary random access preamble may arrive at the base station with only a timing error within the CP length. FIG. 15 illustrates secondary random access preambles 1521 and 1522 transmitted by terminals in different locations. Even if the terminals have received the commands for TA, the secondary random access preambles 1521 and 1522 may generally not be received within a period of the DFT window 1511. This is because the command for TA is determined as a correction value in units of a CP.

As illustrated in FIG. 15, when the secondary random access preamble is received with only a timing error within the CP length, the base station may easily calculate a arrival delay time of the secondary random access preamble by using correlation. In other words, a timing at which the secondary random access preamble is actually received may be calculated (or inferred) by using the CP 1411, the first partial OFDM symbol 1412, and the second partial OFDM symbol 1413 described in FIG. 14. A value calculated in the above-described manner may be secondary TA information, which will be described later. The secondary TA information may be information use for adjusting an uplink transmission timing of data (or signal or message) at the terminal. In addition, primary TA may be information for correcting an uplink transmission timing of data (or signal or message) to have an error within a CP length, and the secondary TA information may be information for compensating therefor. More strictly, the secondary TA information may be correction information to estimate an exact location of the CP and preamble.

Meanwhile, in FIGS. 14A, 14B, and 15, a preamble with a repetitive structure in consideration of improved delay estimation performance and low complexity has been described as a structure of the secondary random access preamble. However, the secondary random access preamble may reuse the random access preamble defined in the 3GPP LTE/NR system. If the secondary random access preamble reuses the random access preamble defined in the 3GPP LTE/NR system, the present disclosure may be applied without the step of generating the secondary random access preamble.

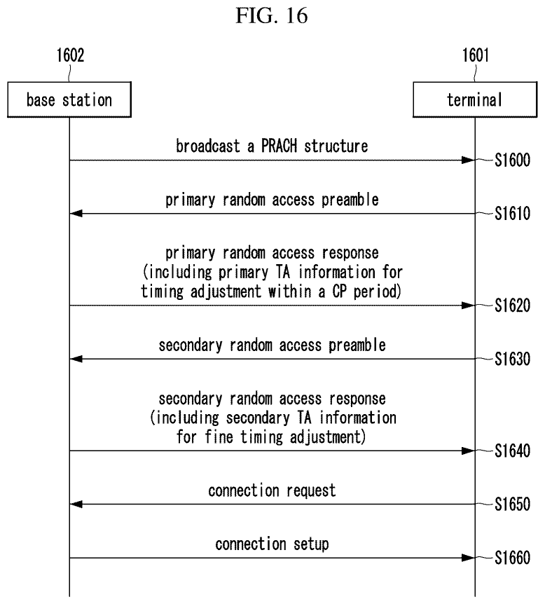

FIG. 16 is a sequence chart illustrating a random access procedure when using a secondary random access preamble.

In step S1600, a base station 1602 may broadcast information on a PRACH structure. In addition, the base station 1602 may perform downlink synchronization through SSB(s) transmitted for downlink. In other words, a terminal 1601 that receives the SSB(s) transmitted by the base station 1602 may perform downlink synchronization with the base station 1602. The terminal 1601 may receive an MIB and an SIB from the base station 1602. The terminal 1601 may collect information on a cell by demodulating the MIB/SIB. The terminal 401 may perform uplink synchronization based on the information collected by demodulating the MIB/SIB.

In step S1610, the terminal 1601 may transmit a primary random access preamble to the base station 1602. The primary random access preamble may be a preamble generated based on the description of FIGS. 9A, 9B, and 10, or may be a preamble generated based on the description of FIGS. 11A and 11B.

In step S1610, the base station 1602 may receive the primary random access preamble from the terminal 1061. In addition, the base station 1602 may generate primary TA information for timing adjustment within a CP period based on the received primary random access preamble.

In step S1620, the base station 1602 may transmit a primary random access response to the terminal 1601. The primary random access response may include the primary TA information for timing adjustment within a CP period. Additionally, the primary random access response may further include a preamble identifier (ID) and a UL grant message. Meanwhile, the primary TA information described in FIG. 16 may be the command for TA described previously in FIG. 13. In other words, the primary TA information and the command for TA described in FIG. 13 may be the same information.

In step S1620, the terminal 1601 may receive the primary random access response from the base station 1602. The terminal 1601 may identify whether it is a response to the primary random access preamble which the terminal 1601 transmitted based on the preamble ID and the UL grant message included in the primary random access response. If the primary random access response is a response to the primary random access preamble transmitted by the terminal 1601, the terminal 1601 may obtain the primary TA information included in the primary random access response. Accordingly, the terminal 1601 may determine a transmission timing so that a preamble transmitted by itself has a reception timing within a CP period at the base station 1602. In other words, the terminal 1601 may adjust an uplink transmission timing based on the primary TA information. Then, the terminal 1601 may generate a secondary random access preamble. The secondary random access preamble may be generated as previously described in FIGS. 14A and 14B.

In step S1630, the terminal 1601 may transmit the secondary random access preamble at the transmission timing adjusted based on the primary TA information. Therefore, in step S1630, the base station 1602 may receive the secondary random access preamble at a timing adjusted based on the primary TA information. The base station may generate secondary TA information for fine timing adjustment based on the received secondary random access preamble. In other words, the secondary TA information may be generated to more precisely adjust the timing adjusted within the CP period.

In step S1640, the base station 1602 may transmit a secondary random access response to the terminal 1601. The secondary random access response may include a preamble ID, a UL grant message, and the secondary TA information for fine timing adjustment. Accordingly, the terminal 1601 may receive the secondary random access response in step S1640, and may identify whether the received response is a response for itself based on the preamble ID and UL grant message included in the secondary random access response. In addition, the terminal 1601 may obtain the secondary TA information included in the secondary random access response.

In step S1650, the terminal 1601 may transmit a connection request to the base station 1602. The connection request transmitted to the base station 1602 may be transmitted at a transmission timing finely adjusted based on the primary TA information and secondary TA information. In step S1650, the base station 1602 may receive the connection request from the terminal 1601.

In step S1660, the base station 1602 may transmit a connection setup to the terminal 1601 in response to the connection request received from the terminal 1601.

The response, request, and/or setup described in FIG. 16 described above may be transmitted as specific messages or signals.

As described above, the terminal may perform initial access using the primary random access preamble and the secondary random access preamble according to the present disclosure. In particular, applying the random access procedure according to the present disclosure, asynchronous grant-free NOMA can be supported in the 5G NR/NTN mobile communication network with a large cell radius under a situation where GNSS information of the terminal and ephemeris information of the satellite are not available.

In the present disclosure, in a situation where a difference in transmission delays of non-GNSS terminals exceeds a CP length due to asynchronous grant-free transmissions in a system with a large cell radius, the non-GNSS terminals transmit the primary random access preamble according to the present disclosure, and the base station may estimate the difference in transmission delays that exceeds the CP length. In addition, the present disclosure provides a primary random access process for making the difference in transmission delays between terminals fall within the CP length by transmitting the primary TA information to the non-GNSS terminals.

The primary random access process may be a procedure for transmitting the primary random access preamble and receiving the primary random access response. Additionally, a secondary random access process may be a procedure in which the base station estimates the difference in transmission delays within the CP length based on transmission of the secondary random access preamble and transmits transmission timing adjustment commands to the terminals. Therefore, the 6-step random access procedure according to the present disclosure may be understood as having the additional primary random access process compared to the random access process of the existing 5G NR/LTE.

In the secondary random access process, the secondary random access preamble structure proposed in the present disclosure may be used, or the random access preamble of the existing 5G NR/LTE may be reused as it is.

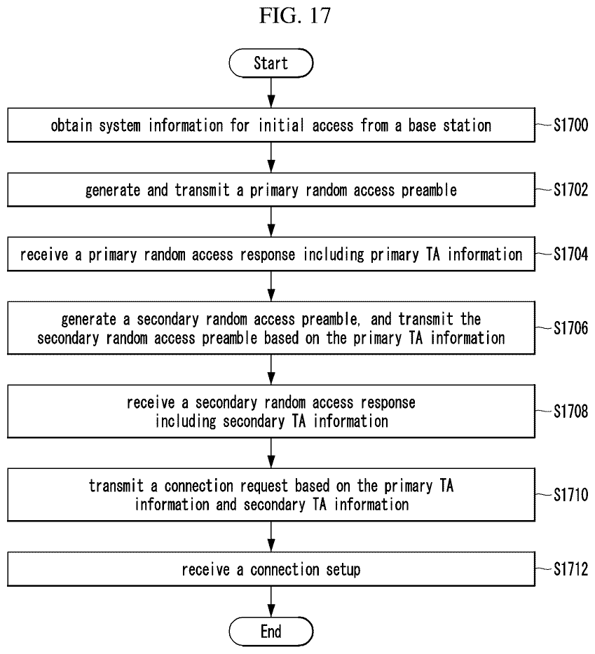

FIG. 17 is a flowchart for describing operations of a terminal during a 6-step random access procedure according to the present disclosure.

Referring to FIG. 17, in step S1700, the terminal may receive system information for initial access from the base station. In other words, the terminal may obtain downlink synchronization through SSB(s) transmitted by the base station, and collect information on a cell by receiving an MIB/SIB.

In step S1702, the terminal may generate a primary random access preamble based on the collected information on the cell, and transmit it to the base station. Since the primary random access preamble has already been described in the previous drawings and descriptions, redundant description will be omitted.

In step S1704, the terminal may receive a primary random access response including a preamble ID, UL grant message, and primary TA information from the base station. As described above, the primary TA information may be information for timing adjustment within a CP period. Additionally, based on the preamble ID and the UL grant message, the terminal may identify whether the primary random access response received by the terminal is a primary random access response for itself.

In step S1706, the terminal may generate a secondary random access preamble. The secondary random access preamble may have a structure repeated twice as described above, or may have a preamble structure according to the current 3GPP NR specifications or a preamble structure defined according to the current 3GPP LTE specifications. The terminal may transmit the secondary random access preamble to the base station based on the primary TA information previously received from the base station in step S1706.

In step S1708, the terminal may receive a secondary random access response including a preamble ID, UL grant message, and secondary TA information. The terminal may identify whether the secondary random access response is a response for itself based on the preamble ID and UL grant message. In addition, if the secondary random access response is a response for the terminal, the terminal may further adjust (or correct) an uplink transmission timing based on the secondary TA information.

In step S1710, the terminal may transmit a connection request based on the primary TA information and the secondary TA information.

In step S1712, the terminal may perform a connection setup procedure with the base station.

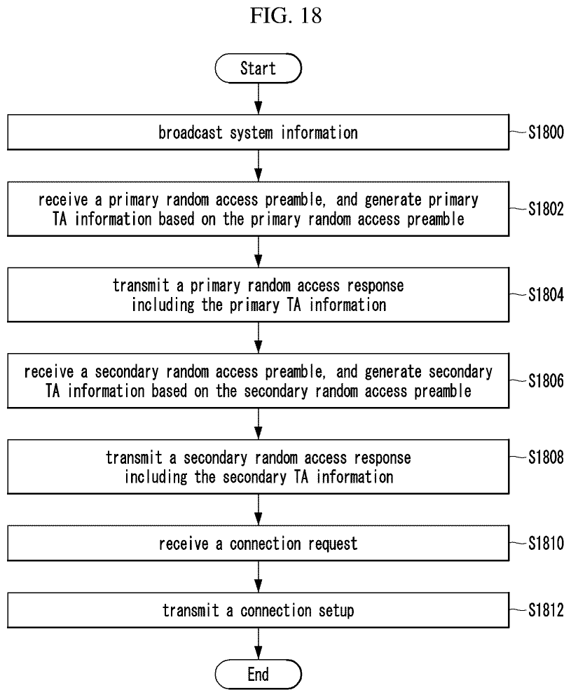

FIG. 18 is a flowchart for describing operations of a base station during a 6-step random access procedure according to the present disclosure.

Referring to FIG. 18, in step S1800, the base station may broadcast system information. In other words, the base station may transmit SSB(s) to provide downlink synchronization to terminals, and transmit an MIB and SIB including information on a cell.

In step S1802, the base station may receive a primary random access preamble. The base station may generate primary TA information for timing adjustment within a CP period based on the received primary random access preamble.

In step S1804, the base station may transmit a primary random access response including a preamble ID, a UL grant message, and the primary TA information to the terminal. As described above, the primary TA information may be information for timing adjustment within a CP period.

In step S1806, the base station may receive a secondary random access preamble from the terminal. Accordingly, the base station may generate secondary TA information based on the received secondary random access preamble.

In step S1808, the base station may transmit a secondary random access response including a preamble ID, a UL grant message, and the secondary TA information to the terminal.

In step S1810, the base station may receive a connection request from the terminal.

In step S1812, the base station may perform a connection setup procedure with the terminal in response to the connection request received in step S1810.

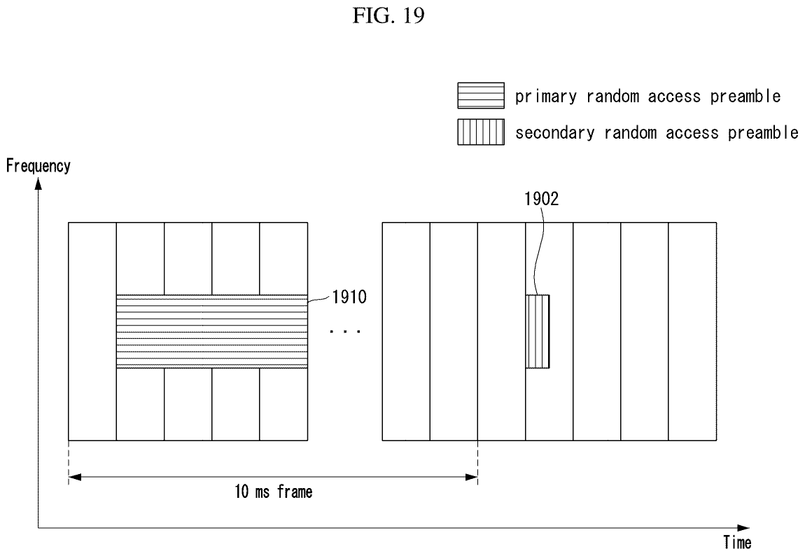

FIG. 19 is a conceptual diagram for describing transmission timings of the primary PRACH preamble and the secondary PRACH preamble based on the 6-step random access procedure according to the present disclosure.

Referring to FIG. 19, a primary random access preamble 1901 and a secondary random access preamble 1902 are illustrated. The primary random access preamble 1901 is transmitted in a period configured as a 10 ms frame, and the secondary random access preamble 1902 is transmitted in a frame after the 10 ms frame in which the primary random access preamble 1901 is transmitted.

As shown in FIG. 19, the frame in which the primary random access preamble is transmitted is referred to as a primary frame, and the frame in which the secondary random access preamble is transmitted is referred to as a secondary frame. Interference between random access channels may be prevented by distinguishing between the primary frame and the secondary frame as shown in FIG. 19.

In addition, a time length of a primary PRACH on which the primary random access preamble is transmitted may need to be set larger than the maximum difference in transmission delays of terminals considered in an operating environment of the mobile communication network, such as NTN with a large cell radius. To illustrate this, FIG. 19 shows a case where the primary random access preamble is transmitted in a period of 4 subframes.

Compared to the primary random access preamble, a time length of a secondary PRACH on which the secondary random access preamble is transmitted may be only the length of two OFDM symbols, similarly to that of the existing NR/LTE.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a terminal, comprising:
obtaining random access preamble generation information from a base station;
generating a primary random access preamble based on the random access preamble generation information;
transmitting the generated primary random access preamble to the base station;
receiving a primary random access response including primary timing advance (TA) information from the base station;
generating a secondary random access preamble based on the primary random access response;
transmitting the secondary random access preamble to the base station based on the primary TA information;
receiving a secondary random access response including secondary TA information from the base station; and
transmitting a connection request to the base station at a transmission timing based on the primary TA information and the secondary TA information,
wherein the first random access preamble and the second random access preamble have different configurations.

2. The method according to claim 1, wherein in the generating of the primary random access preamble, if a length of an orthogonal frequency division multiplexing (OFDM) symbol for the primary random access preamble is n times a length of a cyclic prefix (CP) for the primary random access preamble, the primary random access preamble is generated to have a structure repeated in units of the length of the CP, and n is a natural number.

3. The method according to claim 2, wherein when the primary random access preamble is generated to have the structure repeated in units of the length of the CP, the primary random access preamble is transmitted in subcarriers having indices (n×k) in a frequency domain of the OFDM symbol, and k is an integer.

4. The method according to claim 1, wherein in the generating of the primary random access preamble, if a length of an OFDM symbol for the primary random access preamble is not n times a length of a CP for the primary random access preamble, the primary random access preamble is generated to have a structure in which the OFDM symbol is repeated in units of a greatest common divisor of a number of samples for the CP and a number of samples for the OFDM symbol, and n is a natural number.

5. The method according to claim 4, wherein when the primary random access preamble is generated to have the structure in which the OFDM symbol is repeated in units of the greatest common divisor, the primary random access preamble is transmitted in subcarriers having indices corresponding to integer multiples of a repetition factor p within the OFDM symbol of the primary random access preamble, and p is a natural number.

6. The method according to claim 1, wherein in the generating of the secondary random access preamble, the secondary random access preamble is generated by repeating an OFDM symbol for the secondary random access preamble twice in time, excluding a cyclic prefix for the secondary random access preamble.

7. The method according to claim 1, wherein the primary TA information is information for adjusting an uplink timing within a CP period, and the secondary TA information is information for correcting the primary TA information.

8. The method according to claim 1, wherein the primary random access preamble and the secondary random access preamble are transmitted in different frames, the primary random access preamble is transmitted in a plurality of preconfigured subframes within a frame in which the primary random access preamble is configured to be transmitted, and the secondary random access preamble is transmitted in some symbols of a frame in which the secondary random access preamble is configured to be transmitted.

9. A method of a base station, comprising:
broadcasting random access preamble generation information;
in response to detecting receipt of a primary random access preamble from a terminal, generating primary timing advance (TA) information based on a structure of the primary random access preamble;
transmitting, to the terminal, a primary random access response including a primary random access preamble identifier (ID), an uplink grant message, and the primary TA information;
in response to detecting receipt of a secondary random access preamble from the terminal, generating secondary TA information based on a structure of the secondary random access preamble;
transmitting, to the terminal, a secondary random access response including a secondary random access preamble ID, an uplink grant message, and the secondary TA information; and
establishing a connection with the terminal when a connection request is received from the terminal,
wherein the first random access preamble and the second random access preamble have different configurations.

10. The method according to claim 9, wherein when a length of an orthogonal frequency division multiplexing (OFDM) symbol for the primary random access preamble is n times a length of a cyclic prefix (CP) for the primary random access preamble, the primary random access preamble is generated to have a structure repeated in units of the length of the CP, and n is a natural number.

11. The method according to claim 10, wherein when the primary random access preamble is generated to have the structure repeated in units of the length of the CP, the primary random access preamble is received in subcarriers having indices (n×k) in a frequency domain of the OFDM symbol, and k is an integer.

12. The method according to claim 9, wherein when a length of an OFDM symbol for the primary random access preamble is not n times a length of a CP for the primary random access preamble, the primary random access preamble is generated to have a structure in which the OFDM symbol is repeated in units of a greatest common divisor of a number of samples for the CP and a number of samples for the OFDM symbol, and n is a natural number.

13. The method according to claim 12, wherein when the primary random access preamble is generated to have the structure in which the OFDM symbol is repeated in units of the greatest common divisor, the primary random access preamble is received in subcarriers having indices corresponding to integer multiples of a repetition factor p within the OFDM symbol of the primary random access preamble, and p is a natural number.

14. The method according to claim 9, wherein the secondary random access preamble is generated by repeating an OFDM symbol for the secondary random access preamble twice in time, excluding a cyclic prefix for the secondary random access preamble.

15. The method according to claim 9, wherein the primary TA information is information for adjusting an uplink timing within a CP period, and the secondary TA information is information for correcting the primary TA information.

16. The method according to claim 9, wherein the primary random access preamble and the secondary random access preamble are transmitted in different frames, the primary random access preamble is transmitted in a plurality of preconfigured subframes within a frame in which the primary random access preamble is configured to be transmitted, and the secondary random access preamble is transmitted in some symbols of a frame in which the secondary random access preamble is configured to be transmitted.

17. A terminal comprising a processor,
wherein the processor causes the terminal to perform:
obtaining random access preamble generation information from a base station;
generating a primary random access preamble based on the random access preamble generation information;
transmitting the generated primary random access preamble to the base station;
receiving a primary random access response including primary timing advance (TA) information from the base station;
generating a secondary random access preamble based on the primary random access response;
transmitting the secondary random access preamble to the base station based on the primary TA information;
receiving a secondary random access response including secondary TA information from the base station; and
transmitting a connection request to the base station at a transmission timing based on the primary TA information and the secondary TA information,
wherein the first random access preamble and the second random access preamble have different configurations.

18. The terminal according to claim 17, wherein the processor further causes the terminal to perform:
in the generating of the primary random access preamble, if a length of an orthogonal frequency division multiplexing (OFDM) symbol for the primary random access preamble is n times a length of a cyclic prefix (CP) for the primary random access preamble, generating the primary random access preamble to have a structure repeated in units of the length of the CP, and
when the primary random access preamble is generated to have the structure repeated in units of the length of the CP, transmitting the primary random access preamble in subcarriers having indices (n×k) in a frequency domain of the OFDM symbol,
wherein n is a natural number, and k is an integer.

19. The terminal according to claim 17, wherein the processor further causes the terminal to perform:
in the generating of the primary random access preamble, if a length of an OFDM symbol for the primary random access preamble is not n times a length of a CP for the primary random access preamble, generating the primary random access preamble to have a structure in which the OFDM symbol is repeated in units of a greatest common divisor of a number of samples for the CP and a number of samples for the OFDM symbol,
wherein n is a natural number.

20. The terminal according to claim 17, wherein the processor further causes the terminal to perform:
in the generating of the secondary random access preamble, generating the secondary random access preamble by repeating an OFDM symbol for the secondary random access preamble twice in time, excluding a cyclic prefix for the secondary random access preamble.
